(19) United States
(12) Patent Application Publication
(10) Pub. No.: US 2004/0057078 A1
(43) Pub. Date: Mar. 25, 2004

(54) Method and system for printing

(76) Inventor: Roderick Franklin Coffin III, Austin, TX (US)

Correspondence Address: BAKER BOTTS L.L.P., 2001 ROSS AVENUE, SUITE 600, DALLAS, TX, 75201-2980, US

(21) Appl. No.: 10/251,903

(22) Filed: Sep. 20, 2002

(51) Int. Cl. G06F 3/12; G06F 13/00; G06K 15/02

(52) U.S. Cl. 358/1.17; 345/545

(57) ABSTRACT

According to one embodiment of the invention, a computerized method for printing graphical images includes exposing a memory device context associated with a graphical image rendered on a display of a computer, the memory device context storing a plurality of bits defining the graphical image. The method also includes accessing the plurality of bits and formatting the bits for printing, and printing the plurality of bits.

### TECHNICAL FIELD OF THE INVENTION

This invention relates generally to computer systems and more particularly to a method and system for printing.

### BACKGROUND OF THE INVENTION

Computers are becoming increasingly important in today's society. Internet browsers have become pervasive and commonplace among computer users. Often it is desirable to print what is displayed by the Internet browser. One example of an Internet browser is Microsoft's Internet Explorer. When printing, Microsoft's Internet Explorer reformats the displayed page differently on the printed output than it appears on the screen. This reformatting is generally intended to produce output that is more appropriately formatted for printed output, but in some cases this is not desired or, as with complicated DHTML pages, this output actually leaves off possibly significant elements of the page. Furthermore, ActiveX controls embedded within web pages are often not expanded correctly onto the printed page. ActiveX controls refer generally to executable programs that have a visible interface. These are generally used with the Windows operating system. This printing dilemma is further aggravated if these complicated elements exist within a frameset in the web page.

It is also commonplace to have more than one frame displayed by a browser on the same screen. A user may wish to print contents of each frame; however, the portion of the frame that actually is displayed on the screen is all that can be printed according to conventional techniques. Thus, a user must expand any given frame to occupy essentially the full screen and then print. Thus, it can be time-consuming to print multiple frames displayed on the screen.

### SUMMARY OF THE INVENTION

According to one embodiment of the invention, a computerized method for printing graphical images includes exposing a memory device context associated with a graphical image rendered on a display of a computer, the memory device context storing a plurality of bits defining the graphical image. The method also includes accessing the plurality of bits and formatting the bits for printing, and printing the plurality of bits.

Some embodiments of the invention provide numerous technical advantages. Some embodiments may benefit from some, none, or all of these advantages. For example, according to one embodiment, a user may print an image displayed on a computer screen such that the image that is printed is exactly in the form as displayed on the computer screen (or that which would be displayed if the entire image were displayed). Because of this, problems associated with programs attempting to format images, but not being successful, may be overcome, and graphical images may be appropriately printed. According to some embodiments, multiple images displayed on a screen at the same time may also be printed to the printer without requiring the user to enlarge each window displaying each image and then print each image separately.

Other technical advantages may be readily ascertained by one of skill in the art.

### BRIEF DESCRIPTION OF THE DRAWINGS

Reference is now made to the following description taken in conjunction with the accompanying drawings, wherein like reference numbers represent like parts, in which:

FIG. 1A is a block diagram showing a computer system that may benefit from the teachings of the invention;

FIG. 1B is a schematic diagram showing the computer display of FIG. 1A displaying an Internet browser;

FIG. 1C is a block diagram showing in greater detail the memory of FIG. 1A;

FIG. 2A is a schematic diagram showing a computer display according to one embodiment of the invention;

FIG. 2B is a flowchart showing example steps associated with printing the contents of the display of FIG. 2A according to the teachings of the invention;

FIG. 3A is a schematic diagram showing a display according to another embodiment of the invention; and

FIG. 3B is a flowchart showing example steps associated with printing the contents of the display of FIG. 3A according to another embodiment of the invention.

### DETAILED DESCRIPTION OF THE INVENTION

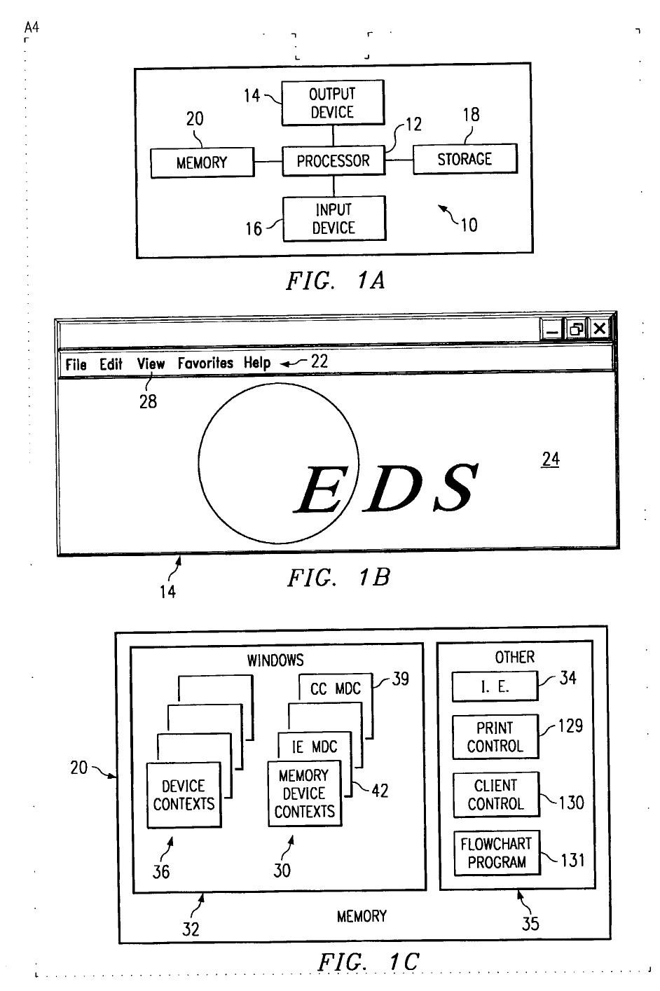

Embodiments of the invention are best understood by referring to FIGS. 1A through 3B of the drawings, like numerals being used for like and corresponding parts of the various drawings.

FIG. 1A is a block diagram illustrating a computer system 10 that may benefit from the teachings of the invention. Computer system 10 includes a processor 12 that is coupled to one or more output devices 14 and one or more input devices 16. In one example, output device 14 is a computer display or a printer. Processor 12 is also coupled to a storage area 18 and a memory 20. Processor 12 is operable to execute the logic of programs stored in memory 20 or storage 18. Examples of processor 12 are the Pentium series processors available from Intel Corporation; however, any type of processor may be used without departing from the teachings of the invention. Memory 20 and storage 18 may comprise files, stacks, databases, or other suitable forms of data. Memory 20 and storage 18 may be random access memory, read-only memory, CD-ROM, removable memory devices or other suitable devices that allow storage and/or retrieval of data. Memory 20 and storage 18 may be interchangeable and may perform the same functions. However, in the below examples, memory 20 will be used for storage and retrieval of data conventionally stored in random access memory, and storage 18 will perform the functions associated with data conventionally stored in read-only memory.

FIG. 1B is a schematic diagram of the display on output device 14 of FIG. 1A. As illustrated, a web browser 22 is displayed on display 14. In this example the web browser is Microsoft's Internet Explorer web browser; however, any type of browser may be used. Also, as described in greater detail below, the teachings of the invention are applicable in contexts other than web browsers, but a web browser is used for example purposes. In this example, web browser 22 is a program executing within the Windows operating system (not explicitly shown). Displayed by web browser is, in this example, HTML text that is rendered into a graphical image 24. In this example graphical image 24 corresponds to a fictional eds.com homepage. Web browser 22 also displays a menu bar including a plurality of options.

Often a user wishes to print graphical image 24 to the printer so that he may have a hard copy of what is displayed. As described above, Internet Explorer conventionally reformats graphical image 24 differently on the printed output than it appears on the screen, intending to produce output that is more appropriately formatted for printed paper. However, in some cases this is not desired or, as with complicated DHTML pages, this output actually leaves off possibly significant elements on the page.

As described in greater detail below, the teachings of the invention recognize these disadvantages, and ways they may be overcome, and allow printing of graphical image 24 in the way that it would appear on the display, whether or not the entire image is actually displayed on the display 14.

FIG. 1C is a block diagram of memory 20 of computer system of FIG. 1A. Memory 20 may be described as having various allocated memory locations. In the illustrated embodiment, memory 20 comprises an operating system allocation, which in this example is a Microsoft Windows allocation 32, and an “other” allocation 35. These various allocations correspond to the memory space in memory 20 that stores data associated with the Windows operating system and other programs, respectively.

The Windows memory allocation 32 comprises a plurality of device contexts 36 and a plurality of memory device contexts 38. As used herein, and as generally used by Microsoft Corporation who manufactures the Windows OS, a device context refers to the memory space that stores the graphical image displayed on any particular window. For example, graphical image 24, when displayed in its entirety would be stored in a device context 36. If graphical image 24 were displayed in a window that was smaller in size and did not allow display of the entire image without scrolling, the device context 36 corresponding to that graphical image would only store the bits associated with that portion of the graphical image 24 that was actually displayed. As described above, device contexts 36 are stored within the memory space of the operating system, which in this case is the Windows operating system. Conventionally, the address location of device contexts that are stored in the operating system, sometimes referred to as handles, are made available to various programs, meaning that their addresses are made publicly available to other programs desiring them, often through an Application Program Interface (API). Thus, a program running in the Windows operating system could print directly from the various device contexts 36.

Also stored in Windows allocation 32 are a plurality of memory device contexts 38. Memory device contexts 38 are data structures that store a plurality of bits defining a graphical image, which may be displayed. In contrast to device contexts 36, memory device contexts 38 store all bits associated with a particular image and not just the bits that are displayed on a screen at a particular time. A program may have one or more memory device contexts associated with it.

For example, graphical image 24 of FIG. 1B has a memory device context 42 associated with Internet Explorer within Windows memory allocation 32, and memory device context 39 is associated with client control program 130, described in greater detail below. Memory 20 may store a plurality of other types of information, indicated by the other memory allocation 35. Examples include the Internet Explorer application 34, a print control program 129, a client control program 130, and a flowcharting program 131. These programs are described in greater detail below, but may have associated memory device contexts 38 stored within the operating system memory allocation 32.

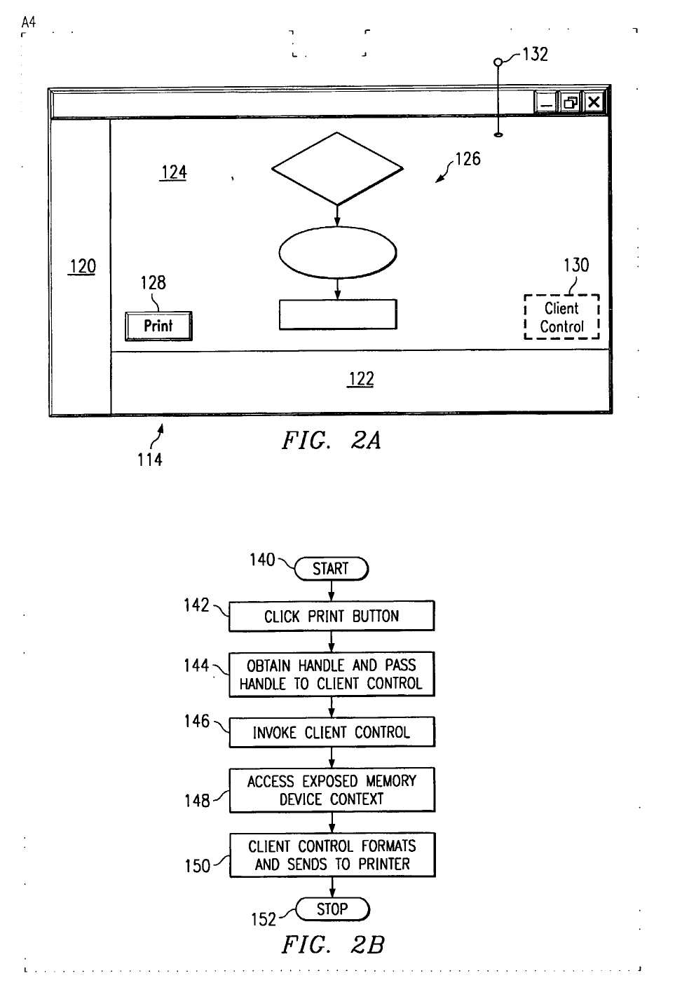

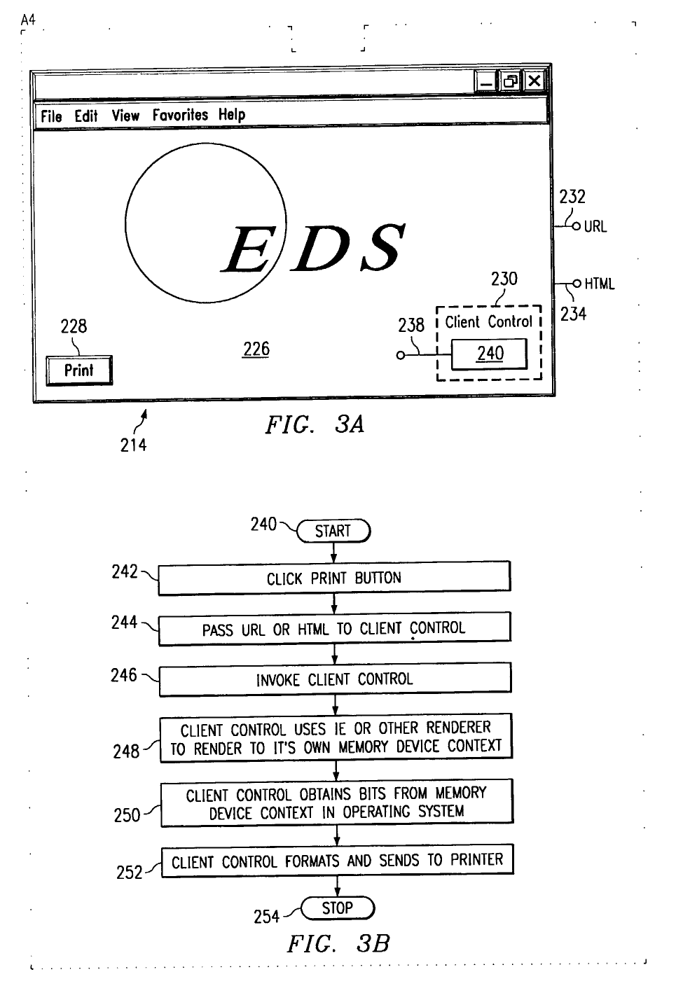

In contrast to device contexts 36, handles, or addresses to, memory device contexts 38 are conventionally not made publicly available to other programs. This is due to the storing of memory device contexts in an associated operating system memory allocation, in some embodiments. Therefore, accessing a memory device context 36 of one program by another program is difficult. According to the teachings of the invention, the handles to memory device context of particular programs are either made publicly available upon creation of the program, or are made publicly available in operation through the use of another program that stores its own memory device context. By having exposed memory device contexts, meaning memory device contexts having handles or addresses that are available to other programs, printing may be effected by streaming the bits stored in the memory device context to an associated printer. Additional details are described in more detail below in conjunction with FIG. 2A through 3B.

FIG. 2A illustrates a display 114 according to the teachings of the invention. Display 114 illustrates three windows 120, 122, and 124. Window 124 displays a graphical image 126, a print control button 128, and a client control program 130. Also illustrated in FIG. 2A is a memory device context indicator 132. Indicator 132 designates that the memory device context associated with the program executing in window 124 to display graphical image 126 is available to other programs, such as programs executing in window 120 and 122. In this example, flowcharting program 131 (FIG. 1C) is the program displaying graphical image 126 in Window 124.

As described above, it is often desirable to print an image, such as image 126, in the format displayed on the display, but some web browsers or other program may not do so effectively. The teachings of the invention recognize that printing graphical image 126 may be accomplished through streaming the bits stored in the memory device context associated with graphical image 126 to the printer for printing. Conventionally, the memory device context 38 associated with the particular graphical image does not have a handle that is available to other programs executing in the operating system, which in this case is Windows. Thus, according to the teachings of the invention the program executing in window 124 is written to make a handle to the memory device context associated with the program available to other programs, such as those executing in windows 120 and 122, as well as programs associated with print control button 128 and client control program 130.

Once the program operating in window 124 (in this example a flow charting program) has been written to expose its memory device context, as indicted by indicator 132, printing of graphical images appearing within window 124 may be accomplished as described below through, in this implementation, a print control program 129 associated with print control button 128 and client control program 130.

Print control button 128 allows access to a print control program, which may be stored in memory 20, as illustrated in FIG. 1C. Alternatively, print control program 129 may be accessed through a link, or through other suitable techniques. Client control program 130 is indicated in dashed lines in FIG. 2A to represent a program that does not visually appear on window 124. Printing of graphical image 126 through print control program 129 and client control program 130 is described in greater detail below in conjunction with FIG. 2B.

Print control program 129 may be written as a Java script; however, any suitable programming language may be used. Client control program 130 may also be written in as a Java script; however, any other suitable programming language may be used. Although print control program 129 and client control program 130 are illustrated as being two separate programs, their functions may be combined into a single program.

FIG. 2B is a flowchart showing example steps associated with printing graphical image 126 in window 124 when the program associated with graphical image 126, in this example flowcharting program 132, has its memory device context exposed or available to other programs executing in the same operating system, as indicated by reference indicator 132. The method begins at step 140. At a step 142 print button 128 is clicked to initiate print control program 129. As described above, rather than utilizing print button 128, a link may be used that initiates execution of print control program when clicked upon. At step 144, print control program 129 obtains the handle to the memory device context associated with flowcharting program 132, which is exposed, and passes the handle to client control program 130. At step 146 print control program 129 initiates client control program 130. At a step 148 the memory device context, or address in memory allocation associated with flowcharting program 132, is accessed by client control program 130. At step 150, client control program 130 obtains the bits stored in the accessed memory device context, formats the bits for printing, and sends to a printer for printing. The method concludes at step 150.

Thus, by printing directly from a memory device context associated with graphical image 126, an image may be displayed on a printer that accurately depicts what is shown on the screen. By exposing a memory device context associated with a particular program, the entire graphical image 126 is available for streaming to the printer.

Writing a program that will expose its memory device context may be performed in many manners. In one particular implementation, generally the following steps are performed. An ActiveX control creates and makes publicly available a memory device context. The ActiveX control draws an image on this memory device context. When display is desired, the ActiveX control paints the visible section of the memory device context onto a device context supplied by the operating system.

Print control program 129 and client control program 130 may be ActiveX controls or other suitable programs. An ActiveX control is one example of a “COM component.” A COM component is a series of interfaces that delivers in a language-independent manner executable code, and an ActiveX control is a COM component that has a visible interface. Thus, in these examples, an ActiveX control is utilized; however, other types of programs may be used.

FIG. 3A is a schematic diagram illustrating a display 214 according to yet another embodiment of the invention. Display 214 illustrates a graphical image 226 displayed within a browser that does not normally have its memory device context exposed, such as Internet Explorer. Thus, printing graphical image 226 by an external program directly from its associated memory device context would conventionally not be possible. According to the teachings of the invention, however, the memory device context associated with a re-rendered image representative of graphical image 226 is exposed through the client control, even though Internet Explorer does not normally expose its memory device contexts, allowing printing of graphical image 226 in the proper format.

Also illustrated in FIG. 3A are indicators 232 and 234. Indicator 232 indicates a link to the URL (uniform resource locator) associated with graphical image 226, and indicator 234 indicates a link to the HTML code associated with graphical image 226. Indicators 232 and 234 indicate that the URL address and the HTML code are accessible by programs running within Internet Explorer, which is conventionally the case with browsers.

Also illustrated in FIG. 3A is a print control button 228 associated with a print control program 229 and client control program 230. Print control program 229 and client control program 230 are similar to programs 129 and 130 described above in FIG. 2A and may be stored in similar locations; however, because the memory device contexts within Internet Explorer are not exposed, client control program also performs functions necessary to expose the memory device context associated with a re-rendered image of image 226, as described in greater detail below. Programs 229 and 230 may also be replaced by a single program.

Also illustrated in FIG. 3A is indicator 238. Indicator 238 indicates the memory device context associated with a pallet, or canvas, 240 associated with client control program 230 is exposed, as described in greater detail below.

According to the teachings of the invention, client control program 230 creates a canvas 240 into which graphical image 226 is re-rendered. Rendering of graphical image 226 into canvas 240 results in a rendered graphical image that has a known memory device context. Once a graphical image is rendered in canvas 240 that has a known memory device context, client control program 230 may print directly from that memory device context to a printer resulting in a graphical image printed in the proper format. Example steps associated with such printing are described in greater detail below in conjunction with FIG. 3B.

FIG. 3B is a flowchart illustrating example steps associated with printing graphical image 226 of FIGURE of FIG. 3A according to the teachings of the invention. The method begins at step 240. At step 242 a user clicks on a print button 228 associated with print control program 229 (not explicitly shown). At step 244 print control program 229 passes the uniform resource locator, indicated by indicator 232, or alternatively the HTML code, indicated by indicator 234, associated with graphical image 226, to client control program 230, and the client control program 230 is invoked, as indicated by reference number 236. At step 248 client control program 230 invokes a renderer, such as the Internet Explorer render, or other renderer, to render the passed HTML code or URL in this example, to the memory device context associated with client control program 230 (client control memory device context 39 in FIG. 1C). At step 250 client control program 230 obtains bits associated with the rendering of the HTML code or URL from memory device context 39 associated with client control program 230. At step 252 client control program 230 formats the bits stored in memory device context 39 associated with client control program 30 and sends them to the printer in the proper format. The process concludes at step 254.

Thus, even though Internet Explorer does not expose its memory device contexts associated with displayed graphical images, a pallet or canvas, in this case canvas 240 of client control program 230, may be created that knows its own memory device context and which may be exposed when needed. Client control program 230 may utilize the rendering function of Internet Explorer or other renderer to write any graphical image desired to be printed to the canvas and then the memory device context associated with that canvas may be exposed for printing. Once the memory device context is exposed printing may be performed.

The teachings of the invention are also applicable in contexts outside the web browser and Internet Explorer implementation of a web browser context. For example, client control program 230 and client control program 228 may also be used in conjunction with common applications such as Word, Excel, and PowerPoint.

Although the present invention has been described in detail, it should be understood that various changes, substitutions, and alterations can be made hereto without departing from the spirit and scope of the invention as defined by the appended claims.

What is claimed is:

1. A computerized method for printing graphical images comprising:
exposing a memory device context associated with a graphical image rendered on a display of a computer, the memory device context storing a plurality of bits defining the graphical image;
accessing the plurality of bits and formatting the bits for printing; and
printing the plurality of bits.

2. The method of claim 1, wherein exposing a memory device context associated with a graphical image comprises exposing, by a program, the memory device context, the program rendering the graphical image on the display.

3. The method of claim 1, wherein exposing the memory device context associated with a graphical image comprises rendering a graphical image within a canvas having an exposed memory device context.

4. The method of claim 1, wherein the graphical image is rendered by Internet Explorer.

5. The method of claim 1, wherein the graphical image is rendered by Microsoft Word.

6. The method of claim 1, wherein the graphical image is rendered by Microsoft Excel.

7. The method of claim 2, wherein the program is encoded to expose its memory device context to other programs.

8. A computerized method for printing graphical images comprising:
providing a program operable to render a graphical image on a display, the program further operable to expose a memory device context associated with the graphical image, the memory device context operable to store a plurality of bits defining the graphical image;
accessing the plurality of bits and formatting the bits for printing; and
printing the plurality of bits.

9. The method of claim 8, wherein printing the plurality of bits comprises executing a print control program operable to print the plurality of bits.

10. The method of claim 8, wherein printing the plurality of bits comprises printing the plurality of bits in response to a click on a visible print button displayed on the display.

11. The method of claim 8, wherein printing the plurality of bits comprises printing the plurality of bits in response to a click on a link displayed on the display.

12. The method of claim 9, wherein accessing the plurality of bits comprises accessing, by a client control program, the plurality of bits, the client control program being a program independent from the print control program.

13. The method of claim 9, wherein accessing the plurality of bits comprises accessing, by a client control program, the plurality of bits, the client control program being a program integral with print control program.

14. A computerized method for printing graphical images comprising:
rendering a graphical image within a canvas having an exposed memory device context, the memory device context storing a plurality of bits defining the rendered graphical image;
accessing the plurality of bits and formatting the bits for printing; and
printing the plurality of bits.

15. The method of claim 14, wherein printing the plurality of bits comprises executing a print control program operable to print the plurality of bits.

16. The method of claim 14, wherein printing the plurality of bits comprises printing the plurality of bits in response to a click on a visible print button displayed on the display.

17. The method of claim 14, wherein printing the plurality of bits comprises printing the plurality of bits in response to a click on a link displayed on the display.

18. The method of claim 15, wherein accessing the plurality of bits comprises accessing, by a client control program, the plurality of bits, the client control program being a program independent from the print control program.

19. The method of claim 15, wherein accessing the plurality of bits comprises accessing, by a client control program, the plurality of bits, the client control program being a program integral with print control program.

20. A computer system comprising:
a processor;
a computer-readable medium accessible by the processor; and
logic encoded on the computer-readable medium operable, when executed on the processor, to:
expose a memory device context associated with a graphical image rendered on a display of a computer, the memory device context storing a plurality of bits defining the graphical image and existing;
access the plurality of bits and formatting the bits for printing; and
print the plurality of bits.

21. The computer system of claim 20, wherein the logic is operable to expose a memory device context associated with a graphical image by exposing the memory device context with the same program rendering the graphical image on the display.

22. The computer system of claim 20, wherein the logic is operable to expose the memory device context associated with a graphical image by rendering a graphical image within a canvas having an exposed memory device context.

23. The computer system of claim 20, and wherein the graphical image is rendered by Internet Explorer.

24. The computer system of claim 20, wherein the graphical image is rendered by Microsoft Word.

25. The computer system of claim 20, wherein the graphical image is rendered by Microsoft Excel.

26. The computer system of claim 21, wherein the program is encoded to expose its memory device context to other programs.

27. A computer system comprising:
a processor;
a computer-readable medium accessible by the processor; and
logic stored in the computer-readable medium and operable to:
render a graphical image on a display, the program further operable to expose a memory device context associated with the graphical image, the memory device context operable to store a plurality of bits defining the graphical image;
access the plurality of bits and formatting the bits for printing; and
print the plurality of bits.

28. The computer system of claim 27, wherein the logic is operable to print the plurality of bits by executing a print control program operable to print the plurality of bits.

29. The computer system of claim 27, wherein the logic is operable to print the plurality of bits by printing the plurality of bits in response to a click on a visible print button displayed on the display.

30. The computer system of claim 27, wherein the logic is operable to print the plurality of bits by printing the plurality of bits in response to a click on a link displayed on the display.

31. The computer system of claim 28, wherein the logic is operable to access the plurality of bits by executing a client control program, the client control program being a program independent from the print control program.

32. The computer system of claim 28, wherein the logic is operable to access the plurality of bits by accessing, by a client control program, the plurality of bits, the client control program being a program integral with print control program.

33. Logic encoded on a computer-readable medium operable, when executed on a processor, to:
render a graphical image within a canvas having an exposed memory device context, the memory device context storing a plurality of bits defining the rendered graphical image;
access the plurality of bits and formatting the bits for printing; and
print the plurality of bits.

34. The logic of claim 33, wherein the logic is operable to print the plurality of bits by executing a print control program operable to print the plurality of bits.

35. The logic of claim 33, wherein the logic is operable to print the plurality of bits by printing the plurality of bits in response to a click on a visible print button displayed on the display.

36. The logic of claim 33, wherein the logic is operable to print the plurality of bits by printing the plurality of bits in response to a click on a link displayed on the display.

37. The logic of claim 34, wherein the logic is operable to access the plurality of bits by executing a client control program, the client control program being a program independent from the print control program.

38. The logic of claim 34, wherein the logic is operable to access the plurality of bits by accessing, by a client control program, the plurality of bits, the client control program being a program integral with print control program.
